(19) United States
(12) Patent Application Publication
(10) Pub. No.: US 2026/0367257 A1
(43) Pub. Date: Nov. 19, 2026

(54) METHOD AND APPARATUS FOR DETERMINING LOCATING SATELLITE

(71) Applicant: Beijing Xiaomi Mobile Software Co., Ltd., Beijing (CN)

(72) Inventor: Yuxin MAO, Beijing (CN)

(21) Appl. No.: 19/127,987

(22) PCT Filed: Nov. 9, 2022
(86) PCT No.: PCT/CN2022/130987

§ 371 Date: May 7, 2025

(51) Int. Cl. G01S 19/28; H04W 48/16; H04W 48/20

(52) U.S. Cl. CPC G01S 19/28; H04W 48/16; H04W 48/20

(57) ABSTRACT

A method for determining a locating satellite is performed by a first network element, and includes: transmitting a first request to a second network element, wherein the first request carries access information of a terminal, the first request is for requesting information of a satellite for locating the terminal, and the second network element is configured to manage or be capable of obtaining satellite network operation information; and receiving satellite information of a locating satellite returned by the second network element, wherein the locating satellite is determined by the second network element based on the access information of the terminal.

### CROSS REFERENCE TO RELATED APPLICATIONS

This application is a US National Phase of International Application No. PCT/CN2022/130987, filed on Nov. 9, 2022, the content of which is incorporated herein by reference in its entirety.

### TECHNICAL FIELD

The present disclosure relates to the field of communication technologies, in particular to a method and apparatus for determining a locating satellite.

### BACKGROUND

When the user equipment (UE) accesses a 5th generation (5G) network by satellite access, the network device of the 5G network needs to verify the location of the terminal equipment to verify whether the user is allowed to access a public land mobile network (PLMN) selected by the terminal equipment at the current location.

In a technical solution, the base station device can report a tracking area ID (TAI) representing the current location of the terminal equipment to the network device of the 5G network, and the network device can verify the location of the terminal equipment based on the TAI. The TAI can be determined based on the location information reported by the terminal equipment, for example, the TAI can be determined based on the information of a global navigation satellite system (GNSS) or a network assisting-GNSS (A-GNSS) reported by the terminal equipment. However, it is not credible to generate, based on the location information generated by any terminal equipment, a TAI representing the location of the terminal equipment, that is, it is possible for the terminal equipment to send a fraudulent location, thus affecting the accuracy of the location of the terminal equipment.

### SUMMARY

According to a first aspect of the embodiments of the present disclosure, there is provided a method for determining a locating satellite, performed by a first network element, and including: transmitting a first request to a second network element, where the first request carries access information of a terminal equipment, the first request is for requesting information of a satellite for locating the terminal equipment, and the second network element is configured to manage or be capable of obtaining satellite network operation information; and receiving satellite information of a locating satellite returned by the second network element, where the locating satellite is determined by the second network element based on the access information of the terminal equipment.

In some embodiments of the present disclosure, the first network element is an access and mobility management function (AMF) network element or a mobility management entity (MME) network element; where the method further includes, after receiving the satellite information of the locating satellite returned by the second network element: transmitting a location request carrying the satellite information of the locating satellite to a location management function (LMF) network element, so that the LMF network element transmits a first location request carrying the satellite information of the locating satellite to a radio access network (RAN) network element, and the first location request is for the LMF network element to instruct the locating satellite to locate the terminal equipment.

In some embodiments, the first network element is an LMF network element, and where the method further includes, before transmitting the first request to the second network element: receiving a second request transmitted by an AMF network element or an MME network element, where the second request includes the access information of the terminal equipment, and the second request is for requesting to locate the terminal equipment.

In some embodiments, the method further includes, after receiving the satellite information of the locating satellite returned by the second network element: transmitting a third request to a radio access network (RAN) network element, where the third request carries the satellite information of the locating satellite, and the third request is for requesting the RAN network element to instruct the locating satellite to locate the terminal equipment.

In some embodiments, the first request further carries indication information, and the indication information is for the second network element to determine the satellite for locating the terminal equipment.

In some embodiments, the second network element is any one of: an application function (AF) network element, a satellite information management server, and a satellite network operation administration and maintenance (OAM) network element.

In some embodiments, the access information of the terminal equipment includes at least one of: location information of the terminal equipment; or movement track information of the terminal equipment.

According to a second aspect of the embodiments of the present disclosure, there is provided a method for determining a locating satellite, performed by a second network element which is configured to manage or be capable of obtaining satellite network operation information, and the method includes: receiving a first request transmitted by a first network element, where the first request is for requesting information of the satellite for locating the terminal equipment, and the first request carries access information of the terminal equipment; determining, based on the access information of the terminal equipment, satellite information of a locating satellite; and returning the satellite information of the locating satellite to the first network element.

In some embodiments, determining, based on the access information of the terminal equipment, the satellite information of the locating satellite includes: determining one or more satellites whose satellite signals cover at least one of a current location or a movement track of the terminal equipment as a locating satellite.

In some embodiments, the method further includes: in response to the first request carrying indication information, determining one or more satellites whose satellite signals cover at least one of a current location or a movement track of the terminal equipment as a locating satellite, where the locating satellite includes a satellite accessed by the terminal equipment.

In some embodiments, the first network element is any one of: an AMF network element, an MME network element, and an LMF network element.

In some embodiments, the second network element is any one of: an AF network element, a satellite information management server, and a satellite network operation administration and maintenance (OAM) network element.

In some embodiments, the access information of the terminal equipment includes at least one of: location information of the terminal equipment; or movement track information of the terminal equipment.

According to a third aspect of the embodiments of the present disclosure, there is provided a method for determining a locating satellite, performed by a first network element, and including: requesting satellite coverage information from a second network element, where the second network element is configured to manage or be capable of obtaining to the satellite coverage information; and receiving the satellite coverage information returned by the second network element, where the satellite coverage information is for determining satellite information of a locating satellite, and the locating satellite is configured to locate a terminal equipment.

In some embodiments, the method further includes, after receiving the satellite coverage information returned by the second network element: determining, based on the satellite coverage information and access information of the terminal equipment, the satellite information of the locating satellite.

In some embodiments, the first network element is an access and mobility management function (AMF) network element or a mobility management entity (MME) network element; and where the method further includes, after determining, based on the satellite coverage information and the access information of the terminal equipment, the satellite information of the locating satellite: transmitting a first location request carrying the satellite information of the locating satellite to a location management function (LMF) network element, where the first location request is for the LMF network element to instruct the locating satellite to locate the terminal equipment.

In some embodiments, the first network element is an AMF network element or an MME network element; and where the method further includes, after receiving the satellite coverage information returned by the second network element: transmitting a second location request to an LMF network element, where the second location request carries the satellite coverage information and access information of the terminal equipment, and the second location request is for the LMF network element to determine the locating satellite based on the satellite coverage information and the access information of the terminal equipment, and to instruct the locating satellite to locate the terminal equipment.

In some embodiments, the first network element is an LMF network element, and where the method further includes, before requesting the satellite coverage information from the second network element: receiving a third location request transmitted by an AMF network element or an MME network element, where the third location request carries access information of the terminal equipment.

In some embodiments, the method further includes, after determining, based on the satellite coverage information and the access information of the terminal equipment, the satellite information of the locating satellite: transmitting a fourth location request to a radio access network (RAN) network element, where the fourth location request carries the satellite information of the locating satellite, and the fourth location request is for requesting the RAN network element to instruct the locating satellite to locate the terminal equipment.

In some embodiments, the access information of the terminal equipment includes at least one of: location information of the terminal equipment; or movement track information of the terminal equipment.

In some embodiments, the second network element is any one of: an AF network element, a satellite information management server, and a satellite network operation administration and maintenance (OAM) network element.

According to a fourth aspect of the embodiments of the present disclosure, there is provided a method for determining a locating satellite, performed by a second network element which is configured to manage or be capable of obtaining satellite network operation information, and the method includes: receiving an obtaining request transmitted by a first network element, where the obtaining request is for requesting to obtain satellite coverage information; and returning the satellite coverage information to the first network element, where the satellite coverage information is for determining satellite information of a locating satellite, and the locating satellite is configured to locate a terminal equipment.

In some embodiments, the first network element is any one of: an access and mobility management function (AMF) network element, a mobility management entity (MME) network element, and a location management function (LMF) network element.

In some embodiments, the second network element is any one of: an AF network element, a satellite information management server, and a satellite network operation administration and maintenance (OAM) network element.

According to a fifth aspect of the embodiments of the present disclosure, there is provided a system for determining a locating satellite, including a first network element and a second network element; where the first network element is configured to perform the method according to the embodiments of the first aspect. The second network element is configured to perform the method according to the embodiments of the second aspect.

According to a sixth aspect of the embodiments of the present disclosure, there is provided a system for determining a locating satellite, including a first network element and a second network element; where the first network element is configured to perform the method according to the embodiments of the third aspect. The second network element is configured to perform the method according to the embodiments of the fourth aspect.

According to an seventh aspect of the embodiments of the present disclosure, there is provided a communication device, including: a transceiver; a memory; and a processor connected to the transceiver and the memory, respectively, where the processor is configured to control transmission and reception of a wireless signal of the transceiver by executing computer-executable instructions on the memory, and realize the method according to the embodiments of the first, second, third or fourth aspect.

According to an eighth aspect of the embodiments of the present disclosure, there is provided a non-transitory computer storage medium, storing instructions thereon, where the instructions, when executed by a processor, cause the processor to perform the method according to the embodiments of the first, second, third or fourth aspect.

### BRIEF DESCRIPTION OF THE DRAWINGS

The foregoing and/or additional aspects and advantages of the present disclosure will become apparent and readily understood from the following description of the embodiments in conjunction with the accompanying drawings.

FIG. 1 is a structural schematic diagram illustrating a system for determining a locating satellite according to an embodiment of the present disclosure.

FIG. 2 is a flowchart illustrating a method for determining a locating satellite according to an embodiment of the present disclosure.

FIG. 3 is a flowchart illustrating a method for determining a locating satellite according to an embodiment of the present disclosure.

FIG. 4 is a flowchart illustrating a method for determining a locating satellite according to an embodiment of the present disclosure.

FIG. 5 is a flowchart illustrating a method for determining a locating satellite according to an embodiment of the present disclosure.

FIG. 6 is a flowchart illustrating a method for determining a locating satellite according to an embodiment of the present disclosure.

FIG. 7 is a flowchart illustrating a locating method according to an embodiment of the present disclosure.

FIG. 8 is a flowchart illustrating a method for determining a locating satellite according to an embodiment of the present disclosure.

FIG. 9 is a flowchart illustrating a locating method according to an embodiment of the present disclosure.

FIG. 10 is a flowchart illustrating a method for determining a locating satellite according to an embodiment of the present disclosure.

FIG. 11 is a flowchart illustrating a method for determining a locating satellite according to an embodiment of the present disclosure.

FIG. 12 is a flowchart illustrating a method for determining a locating satellite according to an embodiment of the present disclosure.

FIG. 13 is a flowchart illustrating a method for determining a locating satellite according to an embodiment of the present disclosure.

FIG. 14 is a flowchart illustrating a method for determining a locating satellite according to an embodiment of the present disclosure.

FIG. 15 is a flowchart illustrating a locating method according to an embodiment of the present disclosure.

FIG. 16 is a flowchart illustrating a method for determining a locating satellite according to an embodiment of the present disclosure.

FIG. 17 is a flowchart illustrating a locating method according to an embodiment of the present disclosure.

FIG. 18 is a block diagram illustrating an apparatus for determining a locating satellite according to an embodiment of the present disclosure.

FIG. 19 is a block diagram illustrating an apparatus for determining a locating satellite according to an embodiment of the present disclosure.

FIG. 20 is a block diagram illustrating an apparatus for determining a locating satellite according to an embodiment of the present disclosure.

FIG. 21 is a block diagram illustrating an apparatus for determining a locating satellite according to an embodiment of the present disclosure.

FIG. 22 is a structural schematic diagram illustrating a communication device according to an embodiment of the present disclosure.

FIG. 23 is a structural schematic diagram illustrating a chip according to an embodiment of the present disclosure.

### DETAILED DESCRIPTION OF THE EMBODIMENTS

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure. It is to be noted that the embodiments in the present disclosure and the features in the embodiments may be combined with each other if there is no conflict.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

When the terminal equipment accesses a 5th generation (5G) network by satellite access, the network device of the 5G network needs to verify the location of the terminal equipment to verify whether the user is allowed to access a public land mobile network (PLMN) selected by the terminal equipment at the current location. For example, because a satellite cell covers a large area, it may cover both the areas of a country A and a country B (for example, a satellite cell covers two countries at the border of the two countries), and the network operators of the two countries may share the satellite access, while the country B requires that users from other countries are prohibited from accessing the operator network of the country B in a non-roaming manner. If the user of the country A located in the border area accesses the network of the country B through the satellite access, the network device of the operator of the country B needs to verify the location of the terminal equipment of the user and judge whether the location of the terminal equipment of the user is located in the country B. If the location of the terminal equipment of the user is not in the country B, the user is prohibited from directly accessing and using the network of the country B in a non-roaming manner.

In a technical solution, the base station device can report a tracking area ID (TAI) representing the current location of the terminal equipment to the network device, and the network device can verify the location of the terminal equipment based on the TAI. The TAI can be determined based on the location information reported by the terminal equipment, for example, the TAI can be determined based on the information of a global navigation satellite system (GNSS) or a network assisting-GNSS (A-GNSS) reported by the terminal equipment. However, it is not credible to generate, based on the location information generated by any terminal equipment, a TAI representing the location of the terminal equipment, that is, it is possible for the terminal equipment to send a fraudulent location. In the process of verifying the location of the terminal equipment, it is necessary to ensure that the obtained location of the terminal equipment is credible. Therefore, the locating method based on the satellite can be used, that is, the terminal equipment is located by the satellite to obtain reliable location information of the terminal equipment and provide the location information to the network device for location verification.

However, the satellite that provide coverage for the terminal equipment will change, for example, a satellite A provides coverage for the terminal equipment in a period T1 and a satellite B provides coverage for the terminal equipment in a period T2. In addition, the coverage of the satellite access to terminal equipment may be discontinuous, and the satellite location can only be carried out when there is signal coverage. In combination with the above-mentioned scenario, when the network device decides to perform location verification on the terminal equipment, it cannot accurately determine the satellite that locates the location of the terminal equipment, thus affecting the accuracy of locating the location of the terminal equipment.

To this end, the embodiment proposes a method and apparatus for determining a locating satellite, which can improve the accuracy of determining the satellite that locates the location of the terminal equipment, and thus can locate the location of the terminal equipment based on the satellite, thereby improving the accuracy of locating the location of the terminal equipment.

The method and apparatus for determining the locating satellite provided by the present disclosure are described in detail below in conjunction with the accompanying drawings.

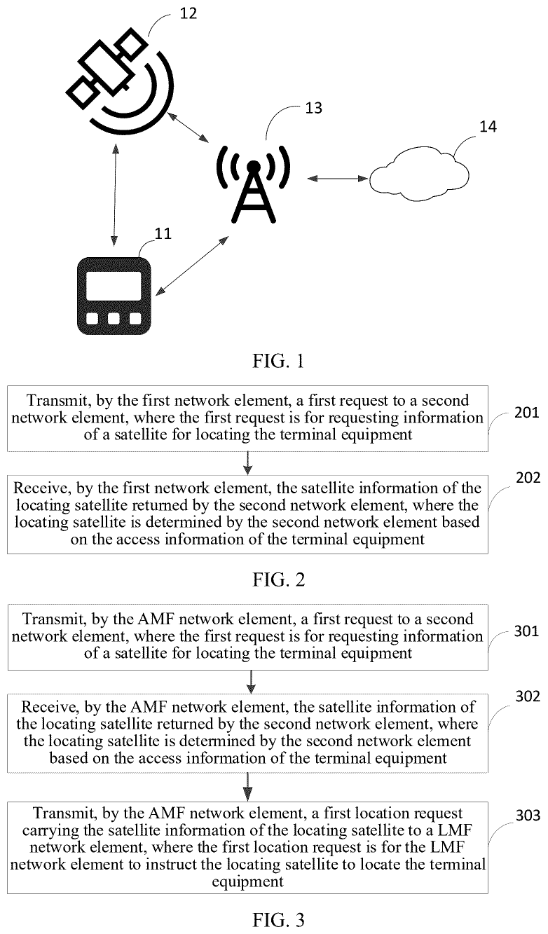

FIG. 1 is a structural schematic diagram illustrating a system for determining a locating satellite according to an embodiment of the present disclosure. As shown in FIG. 1, the network architecture may include at least one terminal equipment 11, at least one satellite 12, a radio access network 13 (e.g., next generation radio access network (NG-RAN)) and a core network 14 (e.g., 5G core network).

In an example, the terminal equipment 11 can access the core network 14 through the radio access network 13. For example, the radio access network can be a satellite access network, that is, the terminal equipment accesses the 5G network by using the satellite access mode.

In an example, the satellite 12 is used to locate the terminal equipment 11. For example, the satellite 12 can be a non-geostationary orbit (NGSO) satellite, such as any one of a low earth orbit (LEO) satellite and a medium earth orbit (MEO) satellite.

In an example, when the core network 14 determines that the terminal equipment 11 uses satellite network access according to the access network used by the terminal equipment 11, it is necessary to verify the location of the terminal equipment 11. In some embodiments of the present disclosure, the core network 14 may determine the information of the satellite 12 that locates the terminal equipment 11, and then instruct the satellite 12 to locate the terminal equipment 11 through the radio access network 13 to obtain the location information of the terminal equipment 11. Because the locating is performed by the satellite, the location is not determined based on the location information (which may be forged) of the terminal equipment 11 itself, so the accuracy of performing location verification on the terminal equipment 11 can be improved.

In some embodiments, the core network 14 may include a first network element and a second network element. The first network element is configured to request the second network element to obtain the information of the satellite for locating the terminal equipment. In an example, the first network element can be an AMF network element, an MME network element, or an LMF network element. The second network element is configured to manage or be capable of obtaining satellite network operation information. In an example, the second network element can be an AF network element, a satellite information management server, or a satellite network operation administration and maintenance (OAM) network element. In this embodiment, the technical solution provided by the embodiment of the present disclosure can be specifically realized by the first network element and the second network element, and the specific content will be described in detail below.

FIG. 2 is a flowchart illustrating a method for determining a locating satellite according to an embodiment of the present disclosure. As shown in FIG. 2, the method is performed by a first network element, and include steps 201 to 102.

At step 201, the first network element transmits a first request to a second network element, where the first request is for requesting information of a satellite for locating the terminal equipment.

For example, the first network element is configured to request the second network element to obtain the information of the satellite for locating the terminal equipment. In an example, the first network element can be an AMF network element, an MME network element, or an LMF network element.

For example, the second network element is configured to manage or be capable of obtaining satellite network operation information. In an example, the second network element can be an AF network element, a satellite information management server, or a satellite network operation administration and maintenance (OAM) network element.

It is to be noted that this embodiment does not specifically limit the names of the first network element and the second network element, and is only an exemplary explanation.

For example, the first request may carry the access information of the terminal equipment, such as information of the terminal equipment for accessing a satellite network. In an embodiment, the access information of the terminal equipment may include at least one of: location information of the terminal equipment; or movement track information of the terminal equipment. The location information of the terminal equipment may include one or more of:
global navigation satellite system (GNSS) information of the terminal equipment, information of tracking area (TA) where the terminal device is located, a cell identity (ID) of a cell serving the terminal equipment, and the 5G base station ID (global node-B-ID (gNB-ID)) accessed by the terminal equipment.

The movement track information of the terminal equipment may include, for example, time-series location information.

In some embodiments, after receiving the first request, the second network element can determine, based on the access information of the terminal equipment carried in the first request, the information of the satellite (also called locating satellite) for locating the terminal equipment. The information for the locating satellite includes, for example, a satellite ID, such as a satellite name or an ID number.

In other embodiments, the second network element can determine the satellite for locating the terminal equipment based on the access information of the terminal equipment and the satellite coverage information (e.g., information such as orbit information and beam coverage area corresponding to each satellite at different times), and return the information (such as satellite identity) of the locating satellite (for locating the terminal equipment) to the first network element. The satellite coverage information includes coverage information of at least one satellite access network.

At step 202, the first network element receives the satellite information of the locating satellite returned by the second network element, where the locating satellite is determined by the second network element based on the access information of the terminal equipment.

In some embodiments, after receiving satellite information (such as satellite identity) of the locating satellite (the satellite for locating the terminal equipment) returned by a second network element, the first network element may provide the satellite information to a radio access network (RAN) network element. The RAN network element instructs the locating satellite (the satellite corresponding to the satellite identity) to locate the terminal equipment to obtain location information of the terminal equipment. Because the locating is performed by the satellite, the location is not determined based on the location information (which may be forged) of the terminal equipment itself, so the accuracy of performing location verification on the terminal equipment can be improved.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 3 is a flowchart illustrating a method for determining a locating satellite according to an embodiment of the present disclosure. For example, the first network element is an AMF network element, as shown in FIG. 3, the method may include steps 301 to 303.

At step 301, the AMF network element transmits a first request to a second network element, where the first request is for requesting information of a satellite for locating the terminal equipment.

The AMF network element is a network element used for access and mobility management in the 5G core network (5GC). The second network element is configured to manage or be capable of obtaining satellite network operation information. In an example, the second network element can be an AF network element, a satellite information management server, or a satellite network operation administration and maintenance (OAM) network element.

In some embodiments, the terminal equipment accesses the 5G core network through a satellite access network, where the satellite access network includes a non-geostationary orbit (NGSO) satellite, such as one or more of: a low earth orbit (LEO) satellite and a medium earth orbit (MEO) satellite. The AMF network element in the 5G core network determines the access mode of the terminal equipment. If it is determined that the terminal equipment accesses the 5G core network through the satellite network, that is, the terminal equipment uses the satellite network access mode, the AMF network element really needs to verify the location of the terminal equipment.

The AMF network element transmits the first request to the second network element to request the information of the locating satellite, which may be a satellite used to locate the terminal equipment. The first request may carry the access information of the terminal equipment, so as to enable the second network element to determine the satellite identity of the locating satellite (the satellite for locating the terminal equipment) based on the access information of the terminal equipment, such as specifically finding the satellite that can locate the terminal equipment in the current access area of the terminal equipment, i.e. the satellite used for locate the terminal equipment, based on the access information of the terminal equipment and the satellite coverage information (e.g., information such as orbit information and beam coverage area corresponding to each satellite at different times).

In an embodiment, the first request transmitted by the AMF network element to the second network element may also carry indication information, which is used to indicate the content returned by the second network. For example, when the first request includes the indication information, the second network element returns satellite information corresponding to the satellite currently used by the terminal equipment when accessing the 5G core network according to the access information of the terminal equipment, and returns satellite information corresponding to other satellites in the satellite network that can cover the current location or movement track of the terminal equipment according to the access information of the terminal equipment, so as to comprehensively locate more accurate location information of the terminal equipment.

Alternatively, when the first request includes the indication information, the second network element returns the satellite information corresponding to the satellite currently used by the terminal equipment when accessing the 5G core network according to the access information of the terminal equipment.

For another example, when the indication information in the first request is a first value, the second network element returns the satellite information corresponding to the satellite currently used by the terminal equipment when accessing the 5G core network according to the access information of the terminal equipment. When the indication information in the first request is a first value, the second network element returns satellite information corresponding to the satellite currently used by the terminal equipment when accessing the 5G core network according to the access information of the terminal equipment, and returns satellite information corresponding to other satellites in the satellite network that can cover the current location or movement track of the terminal equipment according to the access information of the terminal equipment.

At step 302, the AMF network element receives the satellite information of the locating satellite returned by the second network element, where the locating satellite is determined by the second network element based on the access information of the terminal equipment.

For example, the second network element can determine the satellite for locating the terminal equipment based on the access information of the terminal equipment and/or the coverage information of each satellite in the satellite network (e.g., information such as orbit information and beam coverage area corresponding to each satellite at different times). The number of locating satellites determined by the second network element may be one or more.

In an example, the second network element determines that the satellite currently used by the terminal equipment when accessing the 5G core network is used to locate the terminal equipment. In another example, the second network element determines that all or part of the satellites in the satellite network that can cover the current location or movement track of the terminal equipment are used to locate the terminal equipment.

At step 303, the AMF network element transmits a first location request carrying the satellite information of the locating satellite to a LMF network element, where the first location request is for the LMF network element to instruct the locating satellite to locate the terminal equipment.

The LMF network element is used to provide location services for terminal equipment. The RAN network element can be configured to transmit a location instruction to a satellite corresponding to satellite information (such as the satellite identity of the locating satellite) to instruct the satellite to locate the terminal equipment and report the location information of the terminal equipment.

For example, based on the locating method such as multi round trip time (Multi RTT) and downlink/uplink time difference of arrival (DL/UL-TDOA), the terminal equipment can be located by using the satellite corresponding to the satellite identity to obtain reliable location information of the terminal equipment. It is to be noted that the embodiments of the resent disclosure do not limit the method for locating the terminal equipment by the satellite.

It is to be noted that in the embodiment of FIG. 3, the first network element is an AMF network element. In addition, the first network element can also be an MME network element, and the MME network element is also a 5G core network element. The specific implementation process can refer to the implementation process of the AMF network element in the embodiment of FIG. 3, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

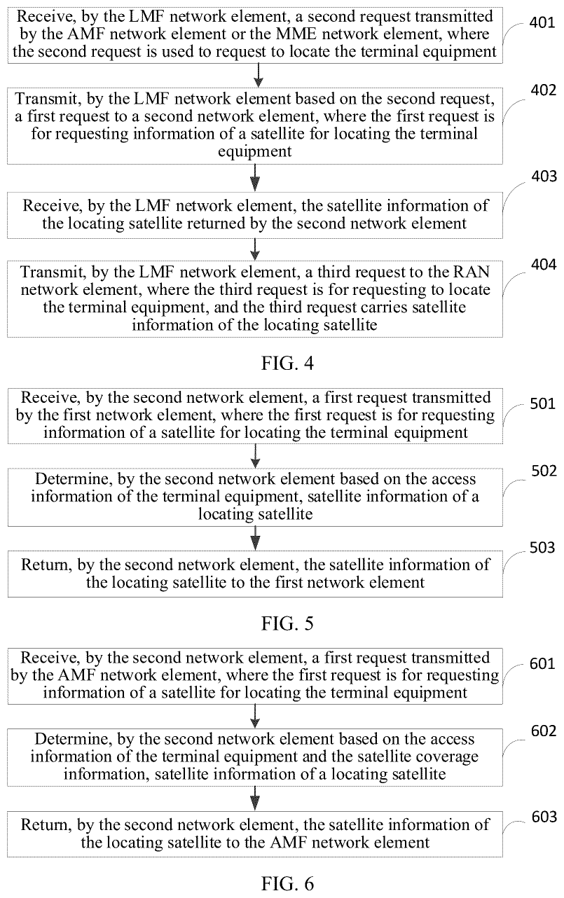

FIG. 4 is a flowchart illustrating a method for determining a locating satellite according to an embodiment of the present disclosure. For example, the first network element is an LMF network element, as shown in FIG. 4, the method may include steps 401 to 404.

At step 401, the LMF network element receives a second request transmitted by the AMF network element or the MME network element, where the second request is used to request to locate the terminal equipment.

The second request includes access information of the terminal equipment.

In some embodiments, the terminal equipment accesses the 5GC through a satellite access network, where the satellite access network is an NGSO satellite (such as LEO or MEO) network, or provides discontinuous coverage of signals. Determining that a terminal equipment uses satellite network access based on the access network used by the terminal equipment requires verification of the location of the terminal equipment. The AMF network element or the MME network element will request satellite information from the LMF network element for locating the location of the terminal equipment, and the request information carries the access information of the terminal equipment.

At step 402, the LMF network element transmits, based on the second request, a first request to a second network element, where the first request is for requesting information of a satellite for locating the terminal equipment.

The second network element can determine the satellite identity of the locating satellite (the satellite for locating the terminal equipment) based on the access information of the terminal equipment, such as determining the satellite that can locate the terminal equipment in the current access area of the terminal equipment, i.e. the satellite used for locate the terminal equipment, based on the access information of the terminal equipment and the satellite coverage information (e.g., information such as orbit information and beam coverage area corresponding to each satellite at different times).

In an embodiment, the first request transmitted by the LMF network element to the second network element may also carry indication information of the requested purpose, and the indication information is for the second network element to determine a satellite for locating the terminal equipment. The details may be found in the description of the embodiment in FIG. 3, and no more tautology here.

At step 403, the LMF network element receives the satellite information of the locating satellite returned by the second network element.

At step 404, the LMF network element transmits a third request to the RAN network element, where the third request is for requesting to locate the terminal equipment, and the third request carries satellite information of the locating satellite.

The RAN network element instructs the locating satellite to locate the terminal equipment. For example, the RAN network element is configured to transmit a location instruction to the satellite corresponding to the satellite information (such as the satellite identity of the locating satellite) to instruct the satellite to locate the terminal equipment and report the location information of the terminal equipment.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 5 is a flowchart illustrating a method for determining a locating satellite according to an embodiment of the present disclosure. As shown in FIG. 5, the method is performed by a second network element, and include steps 501 to 503.

At step 501, the second network element receives a first request transmitted by the first network element, where the first request is for requesting information of a satellite for locating the terminal equipment.

For example, the first network element is configured to request the second network element to obtain the information of the satellite for locating the terminal equipment. In an example, the first network element can be an AMF network element, an MME network element, or an LMF network element.

For example, the second network element is configured to manage or be capable of obtaining satellite network operation information. In an example, the second network element can be an AF network element, a satellite information management server, or a satellite network operation administration and maintenance (OAM) network element.

It is to be noted that this embodiment does not specifically limit the names of the first network element and the second network element, and is only an exemplary explanation.

For example, the first request may carry the access information of the terminal equipment, such as information of the terminal equipment for accessing a satellite network. In an embodiment, the access information of the terminal equipment may include at least one of: location information of the terminal equipment; or movement track information of the terminal equipment. The location information of the terminal equipment may include one or more of: global navigation satellite system (GNSS) information of the terminal equipment, information of tracking area (TA) where the terminal device is located, a cell identity (ID) of a cell serving the terminal equipment, and the 5G base station ID (global node-B-ID (gNB-ID)) accessed by the terminal equipment.

The movement track information of the terminal equipment may include time-series location information.

At step 502, the second network element determines, based on the access information of the terminal equipment, satellite information of a locating satellite.

In some embodiments, the second network element can determine the satellite for locating the terminal equipment based on the access information of the terminal equipment and the satellite coverage information (e.g., information such as orbit information and beam coverage area corresponding to each satellite at different times), and return the information (such as satellite identity) of the locating satellite (for locating the terminal equipment) to the first network element. The satellite coverage information includes coverage information of at least one satellite access network.

For example, one or more satellites whose satellite signals cover at least one of a current location or a movement track of the terminal equipment is determined as a locating satellite.

At step 503, the second network element returns the satellite information of the locating satellite to the first network element.

The execution process of the first network element after obtaining the satellite information of the locating satellite can be referred to in the embodiment shown in FIG. 2, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 6 is a flowchart illustrating a method for determining a locating satellite according to an embodiment of the present disclosure. For example, the first network element is an AMF network element, as shown in FIG. 6, the method may include steps 601 to 603.

At step 601, the second network element receives a first request transmitted by the AMF network element, where the first request is for requesting information of a satellite for locating the terminal equipment.

In some embodiments, the AMF network element is a network element used for access and mobility management in the 5G core network (5GC).

At step 602, the second network element determines, based on the access information of the terminal equipment and the satellite coverage information, satellite information of a locating satellite.

In some embodiments, the second network element can determine the satellite for locating the terminal equipment based on the access information of the terminal equipment and the satellite coverage information (e.g., information such as orbit information and beam coverage area corresponding to each satellite at different times), and return the information (such as satellite identity) of the locating satellite (for locating the terminal equipment) to the AMF network element.

In some embodiments, when the first request carries indication information, determining one or more satellites whose satellite signals cover at least one of a current location or a movement track of the terminal equipment as a locating satellite, where the locating satellite includes a satellite accessed by the terminal equipment.

When the indication information in the first request is a first value, one or more satellites whose satellite signals cover the current location and/or movement track of the terminal equipment are determined to be a locating satellite; and the locating satellite includes a satellite accessed by the terminal equipment. When the indication information in the first request is a second value, the satellite accessed by the terminal equipment is determined to be a locating satellite; where the indication information is for the second network element to determine the satellite for locating the terminal equipment. The first value is different from the second value.

The details may be found in the description of the embodiment in FIG. 3, and no more tautology here.

At step 603, the second network element returns the satellite information of the locating satellite to the AMF network element.

The execution process of the AMF network element after obtaining the satellite information of the locating satellite can be referred to in the embodiment shown in FIG. 3, and will not be repeated here. It is to be noted that in the embodiment of FIG. 6, the first network element is an AMF network element. In addition, the first network element can also be an MME network element, and the MME network element is also a 5G core network element. The specific implementation process can refer to the implementation process of the AMF network element in the embodiment of FIG. 6, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

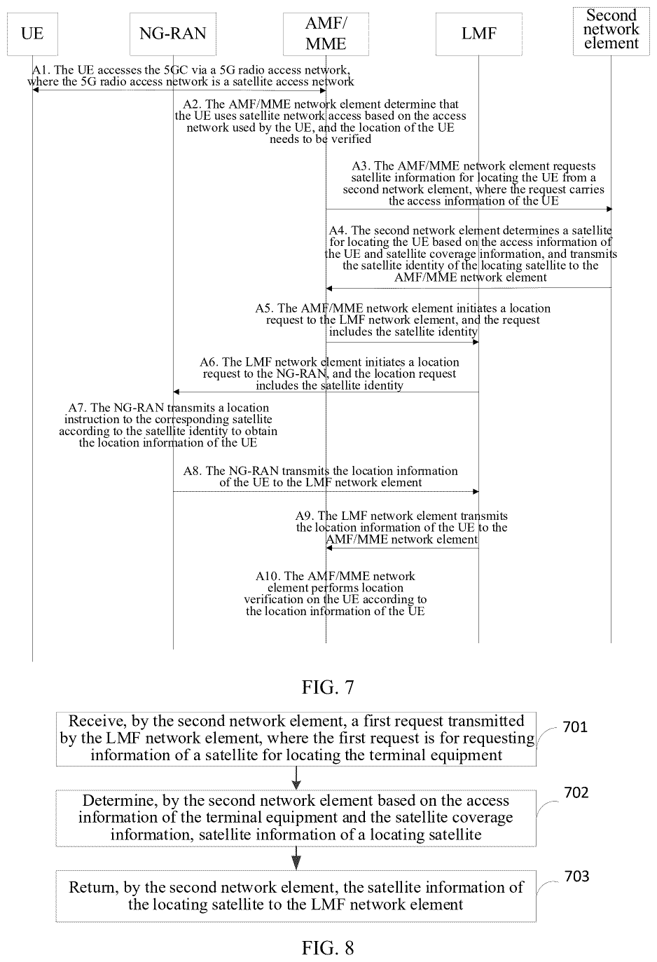

FIG. 7 is a flowchart illustrating a locating method according to an embodiment of the present disclosure. The method can be applied to a system for determining a locating satellite. In FIG. 7, the first network element is an AMF network element or an MME network element. The method includes the following steps A1 to A10.

At step A1, the terminal equipment (for example, a user equipment, UE) accesses the 5GC via a 5G radio access network (NG-RAN), where the 5G radio access network is a satellite access network, which is an NGSO satellite (e.g., LEO or MEO) network, or provides discontinuous coverage of signals.

At step A2, the AMF network element or the MME network element (AMF/MME) in the 5GC determines that the terminal equipment uses satellite network access based on the access network used by the terminal equipment, and the location of the terminal equipment needs to be verified.

This step is an optional step.

At step A3, the AMF network element or the MME network element (AMF/MME) requests satellite information for locating the terminal equipment from a second network element (such as an AF network element/a satellite information management server/an OAM network element).

If the core network uses the service architecture, the AMF network element or the MME network element can request the satellite information from the second network element through the network exposure function (NEF)/service capability exposure function (SCEF). The request message includes the access information of the terminal equipment (such as the location information of the terminal equipment: the GNSS information or the tracking area (TA) where the terminal equipment is currently located). In order to further improve the accuracy of locating the terminal equipment, in some embodiments, the request message may also include indication information indicating that the requested satellite is for locating the terminal equipment.

At step A4, the second network element determines a satellite for locating the terminal equipment based on the access information of the terminal equipment and satellite coverage information, and transmits the satellite identity of the locating satellite to the AMF network element or the MME network element.

At step A5, the AMF network element or the MME network element initiates a location request to the LMF network element, and the request includes the satellite identity.

In some embodiments, the request may be, for example, a Nlmf_Location_DetermineLocation Request.

At step A6, the LMF network element initiates a location request to the NG-RAN, and the location request includes the satellite identity.

At step A7, the NG-RAN transmits a location instruction to the corresponding satellite according to the satellite identity to obtain the location information of the terminal equipment.

At step A8, the NG-RAN transmits the location information of the terminal equipment to the LMF network element.

At step A9, the LMF network element transmits the location information of the terminal equipment to the AMF network element or the MME network element.

In some embodiments, request response information may be received, such as a Nlmf_Location_DetermineLocation Response, and the request response information includes the location information of the terminal equipment.

At step A10, the AMF network element or the MME network element performs location verification on the terminal equipment according to the location information of the terminal equipment.

The embodiments of the present disclosure provide the locating method, which can improve the accuracy of determining the satellite for locating the location of the terminal equipment, and thus improve the accuracy of locating the location of the terminal equipment.

FIG. 8 is a flowchart illustrating a method for determining a locating satellite according to an embodiment of the present disclosure. For example, the first network element is an LMF network element, as shown in FIG. 8, the method may include steps 701 to 703.

At step 701, the second network element receives a first request transmitted by the LMF network element, where the first request is for requesting information of a satellite for locating the terminal equipment.

The LMF network element is configured to interact with the 5G core network to realize the function of locating the terminal equipment.

At step 702, the second network element determines, based on the access information of the terminal equipment and the satellite coverage information, satellite information of a locating satellite.

In some embodiments, the second network element can determine the satellite for locating the terminal equipment based on the access information of the terminal equipment and the satellite coverage information (e.g., information such as orbit information and beam coverage area corresponding to each satellite at different times), and return the information (such as satellite identity) of the locating satellite (for locating the terminal equipment) to the LMF network element.

In some embodiments, when the first request carries the indication information, one or more satellites whose satellite signals cover the current location and/or movement track of the terminal equipment are determined to be a locating satellite; and the locating satellite includes a satellite accessed by the terminal equipment. When the first request does not carry the indication information, the satellite accessed by the terminal equipment is determined to be a locating satellite; where the indication information is for the second network element to determine the satellite for locating the terminal equipment.

When the indication information in the first request is a first value, one or more satellites whose satellite signals cover the current location and/or movement track of the terminal equipment are determined to be a locating satellite; and the locating satellite includes a satellite accessed by the terminal equipment. When the indication information in the first request is a second value, the satellite accessed by the terminal equipment is determined to be a locating satellite; where the indication information is for the second network element to determine the satellite for locating the terminal equipment. The first value is different from the second value.

The details may be found in the description of the embodiment in FIG. 4, and no more tautology here.

At step 703, the second network element returns the satellite information of the locating satellite to the LMF network element.

The execution process of the LMF network element after obtaining the satellite information of the locating satellite can be referred to in the embodiment shown in FIG. 4, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

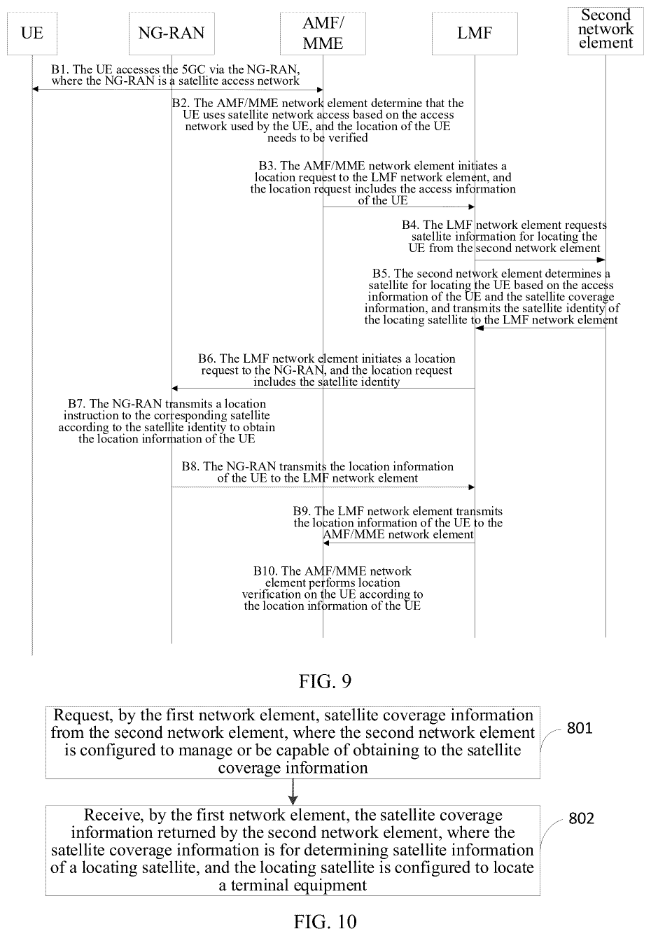

FIG. 9 is a flowchart illustrating a locating method according to an embodiment of the present disclosure. The method can be applied to a system for determining a locating satellite. In FIG. 9, the first network element is an LMF network element. The method includes the following steps B1 to B10.

At step B1, the terminal equipment (for example, a user equipment, UE) accesses the 5GC via a 5G radio access network (NG-RAN), where the 5G radio access network is a satellite access network, which is an NGSO satellite (e.g., LEO or MEO) network, or provides discontinuous coverage of signals.

At step B2, the AMF network element or the MME network element (AMF/MME) in the 5GC determines that the terminal equipment uses satellite network access based on the access network used by the terminal equipment, and the location of the terminal equipment needs to be verified.

At step B3, the AMF network element or the MME network element (AMF/MME) initiates a location request to the LMF network element, and the location request includes the access information of the terminal equipment (such as the location information of the terminal equipment: the GNSS information or the tracking area (TA) where the terminal equipment is currently located).

In some embodiments, the request may be, for example, a NImf_Location_DetermineLocation Request.

At step B4, the LMF network element requests satellite information for locating the terminal equipment from a second network element (such as an AF network element/a satellite information management server/an OAM network element). If the core network uses the service architecture, the LMF network element can request the satellite information from the second network element through the network exposure function (NEF)/service capability exposure function (SCEF). The request message includes access information of the terminal equipment. In order to further improve the accuracy of locating the terminal equipment, in some embodiments, the request message may also include indication information indicating that the requested satellite is for locating the terminal equipment.

At step B5, the second network element determines a satellite for locating the terminal equipment based on the access information of the terminal equipment and satellite coverage information, and transmits the satellite identity of the locating satellite to the LMF network element.

At step B6, the LMF network element initiates a location request to the NG-RAN, and the location request includes the satellite identity.

At step B7, the NG-RAN transmits a location instruction to the corresponding satellite according to the satellite identity to obtain the location information of the terminal equipment.

At step B8, the NG-RAN transmits the location information of the terminal equipment to the LMF network element.

At step B9, the LMF network element transmits the location information of the terminal equipment to the AMF network element or the MME network element.

In some embodiments, request response information may be received, such as a Nlmf_Location_DetermineLocation Response, and the request response information includes the location information of the terminal equipment.

At step B10, the AMF network element or the MME network element performs location verification on the terminal equipment according to the location information of the terminal equipment.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 10 is a flowchart illustrating a method for determining a locating satellite according to an embodiment of the present disclosure. As shown in FIG. 10, the method is performed by a first network element, and include steps 801 to 802.

At step 801, the first network element requests satellite coverage information from the second network element, where the second network element is configured to manage or be capable of obtaining to the satellite coverage information.

The satellite coverage information includes coverage information of at least one satellite access network.

For example, the first network element is configured to request the second network element to obtain the information of the satellite for locating the terminal equipment. In an example, the first network element can be an AMF network element, an MME network element, or an LMF network element.

For example, the second network element is configured to manage or be capable of obtaining satellite network operation information. In an example, the second network element can be an AF network element, a satellite information management server, or a satellite network operation administration and maintenance (OAM) network element.

It is to be noted that this embodiment does not specifically limit the names of the first network element and the second network element, and is only an exemplary explanation.

The second network element may return the satellite coverage information to the first network element after receiving the request.

At step 802, the first network element receives the satellite coverage information returned by the second network element, where the satellite coverage information is for determining satellite information of a locating satellite, and the locating satellite is configured to locate a terminal equipment.

The locating satellite is a satellite for locating the terminal equipment. The present embodiment, after obtaining the satellite information (e.g., a satellite identity) of the locating satellite, may provide the satellite information to the RAN network element. The RAN network element instructs the locating satellite (the satellite corresponding to the satellite identity) to locate the terminal equipment to obtain location information of the terminal equipment. Because the locating is performed by the satellite, the location is not determined based on the location information (which may be forged) of the terminal equipment itself, so the accuracy of performing location verification on the terminal equipment can be improved.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 11 is a flowchart illustrating a method for determining a locating satellite according to an embodiment of the present disclosure. For example, the first network element is AMF network element, as shown in FIG. 11, the method may include steps 901 to 902.

At step 901, the AMF network element requests satellite coverage information from the second network element, where the second network element is configured to manage or be capable of obtaining to the satellite coverage information.

The AMF network element is a 5G core network element. In this embodiment, the terminal equipment accesses the 5GC through a satellite access network, where the satellite access network is an NGSO satellite (such as LEO or MEO) network, or provides discontinuous coverage of signals. The AMF network element determines that a terminal equipment uses satellite network access based on the access network used by the terminal equipment requires verification of the location of the terminal equipment.

The AMF network element requests the satellite coverage information from the second network element, where the satellite coverage information is for determining satellite information of a locating satellite, and the locating satellite is configured to locate a terminal equipment.

At step 902, the AMF network element receives the satellite coverage information returned by the second network element, where the satellite coverage information is for determining satellite information of a locating satellite, and the locating satellite is configured to locate a terminal equipment.

In some embodiments, after step 902, the method may further include: determining, by the AMF network element, satellite information of the locating satellite based on the satellite coverage information and the access information of the terminal equipment. For example, based on the access information of the terminal equipment and the satellite coverage information (including the set of satellites that can be used for the locating), the satellite that corresponds to the current access of the terminal equipment to the satellite network, i.e., the satellite that is for locating the terminal equipment, is found.

After the AMF network element determines the satellite information of the locating satellite according to the satellite coverage information and the access information of the terminal equipment, the method of this embodiment may further include: transmitting a first location request carrying the satellite information of the locating satellite to the LMF network element. The first location request is used for the LMF network element to instruct the locating satellite to locate the terminal equipment, for example, the location request carrying the satellite information of the locating satellite is transmitted to the LMF network element, such that the LMF network element transmits the location request carrying the satellite information of the locating satellite to the RAN network element, and the RAN network element is configured to a location instruction to the locating satellite corresponding to the satellite information to instruct the locating satellite to locate the terminal equipment, and report the location information of the terminal equipment.

In addition to the above-mentioned method that the AMF network element determines the satellite information of the locating satellite by itself, as another alternative, after step 902, this embodiment may further include: transmitting a second location request to the LMF network element. The second location request carries the satellite coverage information and the access information of the terminal equipment, and the second location request is used for the LMF network element to determine the locating satellite according to the satellite coverage information and the access information of the terminal equipment, and instruct the locating satellite to locate the terminal equipment. For example, a location request carrying the satellite coverage information and the access information of the terminal equipment is transmitted to the LMF network element, such that the LMF network element can determine the satellite identity of the locating satellite based on the satellite coverage information and the access information of the terminal equipment, and transmit the location request carrying the satellite identity of the locating satellite to the RAN network element. The RAN network element is configured to transmit a location instruction to the satellite corresponding to the satellite identity to obtain the location information of the terminal equipment.

It is to be noted that in the embodiment of FIG. 11, the first network element is an AMF network element. In addition, the first network element can also be an MME network element, and the MME network element is also a 5G core network element. The specific implementation process can refer to the implementation process of the AMF network element in the embodiment of FIG. 11, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

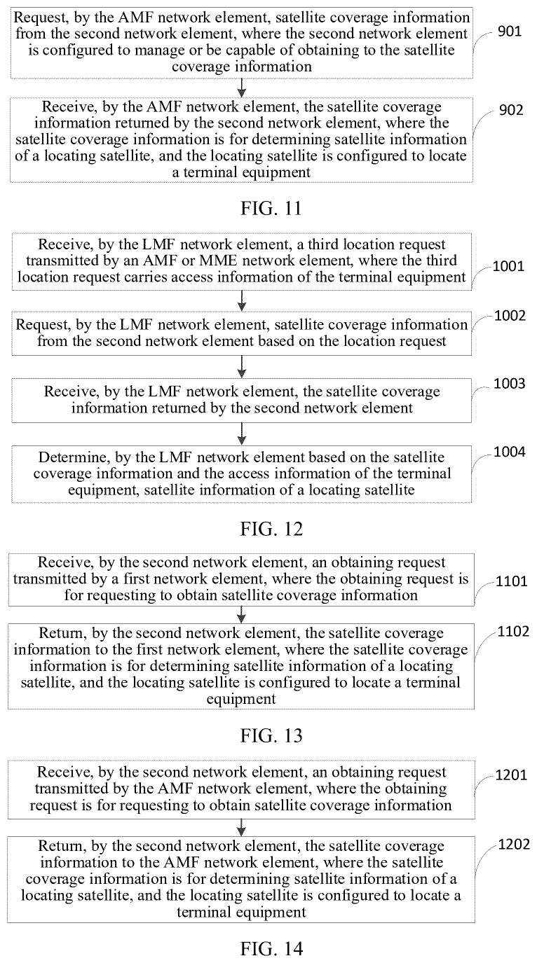

FIG. 12 is a flowchart illustrating a method for determining a locating satellite according to an embodiment of the present disclosure. For example, the first network element is an LMF network element, as shown in FIG. 12, the method may include steps 1001 to 1004.

At step 1001, the LMF network element receives a third location request transmitted by an AMF network element or an MME network element, where the third location request carries access information of the terminal equipment.

The terminal equipment accesses the 5GC through a satellite access network, where the satellite access network is an NGSO satellite (such as LEO or MEO) network, or provides discontinuous coverage of signals. Determining that a terminal equipment uses satellite network access based on the access network used by the terminal equipment requires verification of the location of the terminal equipment. The AMF network element or the MME network element will request satellite information from the LMF network element for locating the location of the terminal equipment, and the request information carries the access information of the terminal equipment.

At step 1002, the LMF network element requests satellite coverage information from the second network element based on the location request.

At step 1003, the LMF network element receives the satellite coverage information returned by the second network element.

At step 1004, the LMF network element determines, based on the satellite coverage information and the access information of the terminal equipment, satellite information of a locating satellite.

The locating satellite is a satellite configured for locating the terminal equipment, for example, a satellite that can be used for the locating in the current access area of the terminal equipment can be determined specifically based on the access information of the terminal equipment and the satellite coverage information, i.e., a satellite for locating the terminal equipment.

In some embodiments, after step 1004, a fourth location request is transmitted to the RAN network element, and the fourth location request carries satellite information of the locating satellite. The fourth location request is for requesting the RAN network element to instruct the locating satellite to locate the terminal equipment, e.g., the LMF network element transmits to the RAN network element a location request carrying a satellite identity of the locating satellite, and the RAN network element is configured to transmit a location instruction to the satellite corresponding to the satellite identity to obtain the location information of the terminal equipment. For example, based on the locating method such as multi round trip time (Multi RTT) and downlink/uplink time difference of arrival (DL/UL-TDOA), the terminal equipment can be located by using the satellite corresponding to the satellite identity to obtain reliable location information of the terminal equipment.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 13 is a flowchart illustrating a method for determining a locating satellite according to an embodiment of the present disclosure. As shown in FIG. 13, the method is performed by a second network element, and include steps 1101 to 1102.

At step 1101, the second network element receives an obtaining request transmitted by a first network element, where the obtaining request is for requesting to obtain satellite coverage information.

For example, the first network element is configured to request the second network element to obtain the information of the satellite for locating the terminal equipment. In an example, the first network element can be an AMF network element, an MME network element, or an LMF network element.

For example, the second network element is configured to manage or be capable of obtaining satellite network operation information. In an example, the second network element can be an AF network element, a satellite information management server, or a satellite network operation administration and maintenance (OAM) network element.

It is to be noted that this embodiment does not specifically limit the names of the first network element and the second network element, and is only an exemplary explanation.

At step 1102, the second network element returns the satellite coverage information to the first network element, where the satellite coverage information is for determining satellite information of a locating satellite, and the locating satellite is configured to locate a terminal equipment.

The satellite coverage information can be for determining satellite information of a locating satellite, and the locating satellite can be configured to locate a terminal equipment.

The execution process of the first network element after obtaining the satellite coverage information can be referred to in the embodiment shown in FIG. 10, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

FIG. 14 is a flowchart illustrating a method for determining a locating satellite according to an embodiment of the present disclosure. For example, the first network element is an AMF network element, as shown in FIG. 14, the method may include steps 1201 to 1202.

At step 1201, the second network element receives an obtaining request transmitted by the AMF network element, where the obtaining request is for requesting to obtain satellite coverage information.

At step 1202, the second network element returns the satellite coverage information to the AMF network element, where the satellite coverage information is for determining satellite information of a locating satellite, and the locating satellite is configured to locate a terminal equipment.

The execution process of the AMF network element after obtaining the satellite coverage information can be referred to in the embodiment shown in FIG. 11, and will not be repeated here.

It is to be noted that in the embodiment of FIG. 14, the first network element is an AMF network element. In addition, the first network element can also be an MME network element, and the MME network element is also a 5G core network element. The specific implementation process can refer to the implementation process of the AMF network element in the embodiment of FIG. 14, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

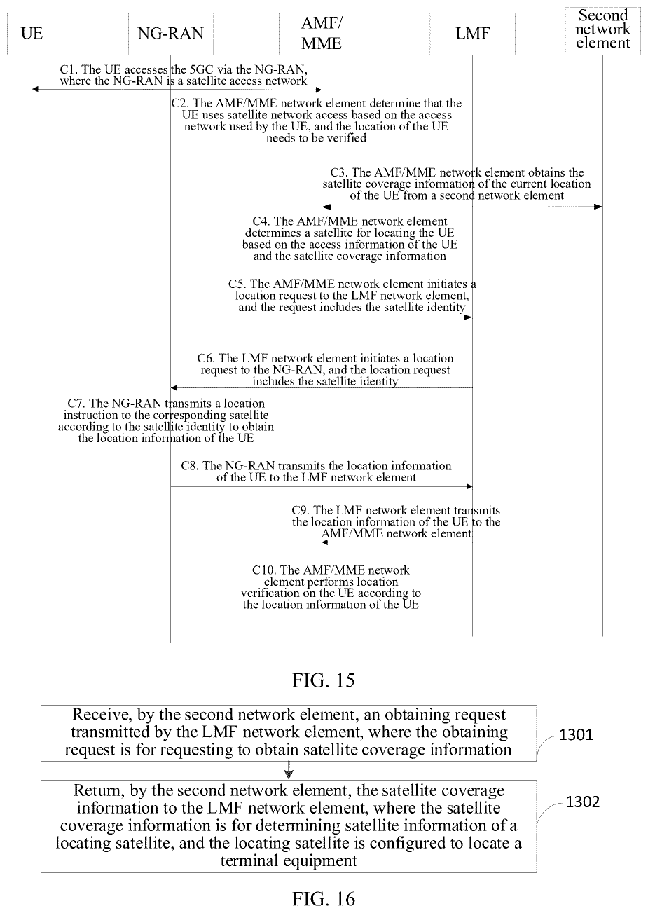

FIG. 15 is a flowchart illustrating a locating method according to an embodiment of the present disclosure. The method can be applied to a system for determining a locating satellite. In FIG. 15, the first network element is an AMF network element or an MME network element. The method includes the following steps C1 to C10.

At step C1, the terminal equipment (for example, a user equipment, UE) accesses the 5GC via a 5G radio access network (NG-RAN), where the 5G radio access network is a satellite access network, which is an NGSO satellite (e.g., LEO or MEO) network, or provides discontinuous coverage of signals.

At step C2, the AMF network element or the MME network element (AMF/MME) in the 5GC determines that the terminal equipment uses satellite network access based on the access network used by the terminal equipment, and the location of the terminal equipment needs to be verified.

At step C3, the AMF network element or the MME network element (AMF/MME) obtains the satellite coverage information of the current location of the terminal equipment from a second network element (e.g., AF network element/satellite information management server/OAM network element, etc.).

At step C4, the AMF network element or the MME network element determines the satellite for locating the terminal equipment based on the access information of the terminal equipment and the satellite coverage information.

At step C5, the AMF network element or the MME network element initiates a location request to the LMF network element, and the request includes the satellite identity.

In some embodiments, the request may be, for example, a NImf_Location_DetermineLocation Request.

At step C6, the LMF network element initiates a location request to the NG-RAN, and the location request includes the satellite identity.

At step C7, the NG-RAN transmits a location instruction to the corresponding satellite according to the satellite identity to obtain the location information of the terminal equipment.

At step C8, the NG-RAN transmits the location information of the terminal equipment to the LMF network element.

At step C9, the LMF network element transmits the location information of the terminal equipment to the AMF network element or the MME network element.

In some embodiments, request response information may be received, such as a NImf_Location_DetermineLocation Response, and the request response information includes the location information of the terminal equipment.

At step C10, the AMF network element or the MME network element performs location verification on the terminal equipment according to the location information of the terminal equipment.

The embodiments of the present disclosure provide the locating method, which can improve the accuracy of determining the satellite for locating the location of the terminal equipment, and thus improve the accuracy of locating the location of the terminal equipment.

FIG. 16 is a flowchart illustrating a method for determining a locating satellite according to an embodiment of the present disclosure. For example, the first network element is an LMF network element, as shown in FIG. 16, the method may include steps 1301 to 1302.

At step 1301, the second network element receives an obtaining request transmitted by the LMF network element, where the obtaining request is for requesting to obtain satellite coverage information.

At step 1302, the second network element returns the satellite coverage information to the LMF network element, where the satellite coverage information is for determining satellite information of a locating satellite, and the locating satellite is configured to locate a terminal equipment.

The execution process of the LMF network element after obtaining the satellite coverage information can be referred to in the embodiment shown in FIG. 12, and will not be repeated here.

The embodiments of the present disclosure provide the method and apparatus for determining a locating satellite, which can improve the accuracy of determining the satellite for locating the location of the terminal equipment, and thus improve the accuracy of locating the location of the terminal equipment.

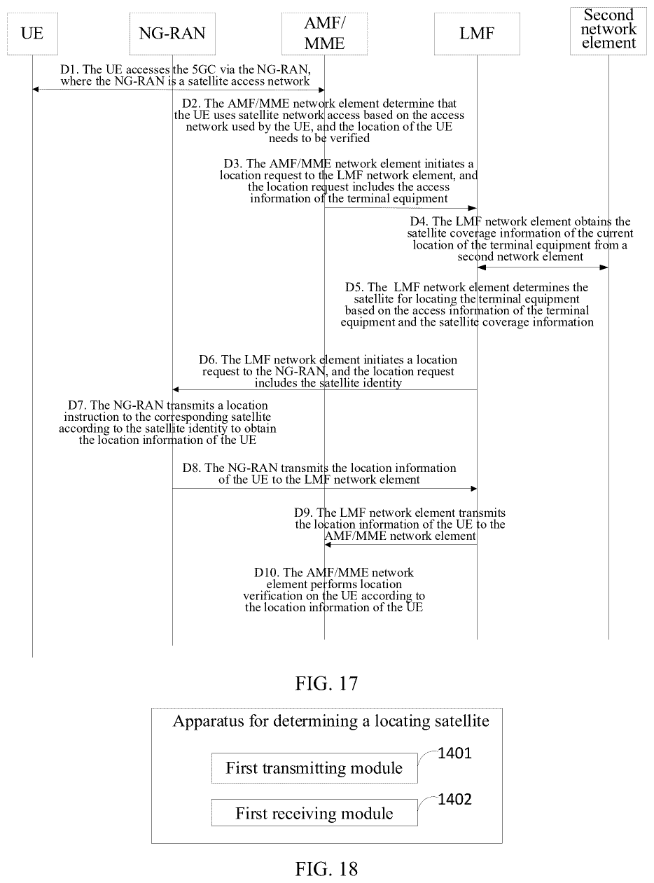

FIG. 17 is a flowchart illustrating a locating method according to an embodiment of the present disclosure. The method can be applied to a system for determining a locating satellite. In FIG. 17, the first network element is an LMF network element. The method includes the following steps D1 to D10.

At step D1, the terminal equipment (for example, a user equipment, UE) accesses the 5GC via a 5G radio access network (NG-RAN), where the 5G radio access network is a satellite access network, which is an NGSO satellite (e.g., LEO or MEO) network, or provides discontinuous coverage of signals.

At step D2, the AMF network element or the MME network element (AMF/MME) in the 5GC determines that the terminal equipment uses satellite network access based on the access network used by the terminal equipment, and the location of the terminal equipment needs to be verified.

At step D3, the AMF network element or the MME network element (AMF/MME) initiates a location request to the LMF network element, and the location request includes the access information of the terminal equipment (such as the location information of the terminal equipment: the GNSS information or the tracking area (TA) where the terminal equipment is currently located).

In some embodiments, the request may be, for example, a NImf_Location_DetermineLocation Request.

At step D4, the LMF network element obtains the satellite coverage information of the current location of the terminal equipment from a second network element (e.g., AF network element/satellite information management server/OAM network element, etc.).

At step D5, the LMF network element determines the satellite for locating the terminal equipment based on the access information of the terminal equipment and the satellite coverage information.

At step D6, the LMF network element initiates a location request to the NG-RAN, and the location request includes the satellite identity of the locating satellite.

At step D7, the NG-RAN transmits a location instruction to the corresponding satellite according to the satellite identity to obtain the location information of the terminal equipment.

At step D8, the NG-RAN transmits the location information of the terminal equipment to the LMF network element.

At step D9, the LMF network element transmits the location information of the terminal equipment to the AMF network element or the MME network element.

In some embodiments, request response information may be received, such as a NImf_Location_DetermineLocation Response, and the request response information includes the location information of the terminal equipment.

At step D10, the AMF network element or the MME network element performs location verification on the terminal equipment according to the location information of the terminal equipment.

The embodiments of the present disclosure provide the locating method, which can improve the accuracy of determining the satellite for locating the location of the terminal equipment, and thus improve the accuracy of locating the location of the terminal equipment.

In the embodiments provided in the present disclosure, the methods provided in the present disclosure are introduced from the perspectives of the first network element and the second network element, respectively. In order to realize each of the functions in the method provided in the embodiments of the present disclosure, the first network element and the second network element may include a hardware structure, a software module, in the form of a hardware structure, a software module, or a hardware structure plus a software module to realize each of the functions. One of the above-mentioned functions can be performed as a hardware structure, a software module, or a hardware structure plus a software module.

Corresponding to the method for determining the locating satellite provided in the embodiments, the present disclosure also provides an apparatus for determining the locating satellite. As the apparatus for determining the locating satellite provided in the present disclosure corresponds to the method for determining the locating satellite provided in the embodiments, the implementation of the method for determining the locating satellite is also applicable to the apparatus for determining the locating satellite provided in the embodiments and will not be described in detail in the embodiments.

FIG. 18 is a block diagram illustrating an apparatus for determining a locating satellite according to an embodiment of the present disclosure. The apparatus for determining the locating satellite can be applied to a first network element.

As shown FIG. 18, the apparatus may include: a first transmitting module 1401, configured to transmit a first request to a second network element, where the first request carries access information of a terminal equipment, the first request is for requesting information of a satellite for locating the terminal equipment, and the second network element is configured to manage or be capable of obtaining satellite network operation information; and a first receiving module 1402, configured to receive satellite information of a locating satellite returned by the second network element, where the locating satellite is determined by the second network element based on the access information of the terminal equipment.

In some embodiments, the first network element is an access and mobility management function (AMF) network element or a mobility management entity (MME) network element; and the first transmitting module 1401 is further configured to: transmit a first location request carrying the satellite information of the locating satellite to a location management function (LMF) network element, where the first location request is for the LMF network element to instruct the locating satellite to locate the terminal equipment.

In some embodiments, the first network element is an LMF network element, and the first receiving module 1402 is configured to receive a second request transmitted by an AMF network element or an MME network element, where the second request includes the access information of the terminal equipment, and the second request is for requesting to locate the terminal equipment.

In some embodiments, the first transmitting module 1401 is further configured to transmit a third request to a radio access network (RAN) network element, where the third request carries the satellite information of the locating satellite, and the third request is for requesting the RAN network element to instruct the locating satellite to locate the terminal equipment.

In some embodiments, the first request further carries indication information, and the indication information is for the second network element to determine the satellite for locating the terminal equipment.

In some embodiments, the second network element can be an AF network element, a satellite information management server, or a satellite network operation administration and maintenance (OAM) network element.

In some embodiments, the access information of the terminal equipment includes at least one of: location information of the terminal equipment; or movement track information of the terminal equipment.

The technical solution the embodiments of the present disclosure can improve the accuracy of determining the satellite for locating the location of the terminal equipment, and thus improve the accuracy of locating the location of the terminal equipment.

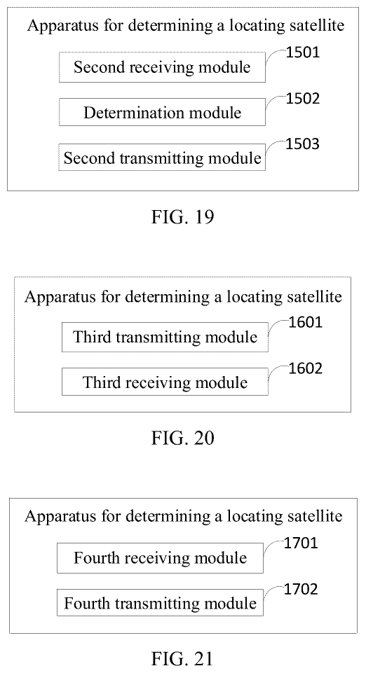

FIG. 19 is a block diagram illustrating an apparatus for determining a locating satellite according to an embodiment of the present disclosure. The apparatus for determining the locating satellite is applied to a second network element.

As shown in FIG. 19, the apparatus may include: a second receiving module 1501, configured to receive a first request transmitted by a first network element, where the first request is for requesting information of the satellite for locating the terminal equipment, and the first request carries access information of the terminal equipment; a determination module 1502, configured to determine, based on the access information of the terminal equipment, satellite information of a locating satellite; and a second transmitting module 1503, configured to return the satellite information of the locating satellite to the first network element.

In some embodiments, the determination module 1502 is specifically configured to: determine one or more satellites whose satellite signals cover at least one of a current location or a movement track of the terminal equipment as a locating satellite.

In some embodiments, the determination module 1502 is further configured to: in response to the first request carrying indication information, determine one or more satellites whose satellite signals cover at least one of a current location or a movement track of the terminal equipment as a locating satellite, where the locating satellite includes a satellite accessed by the terminal equipment.

In some embodiments, the first network element can be an AMF network element, an MME network element, or an LMF network element.

In some embodiments, the second network element can be an AF network element, a satellite information management server, or a satellite network operation administration and maintenance (OAM) network element.

In some embodiments, the access information of the terminal equipment includes at least one of: location information of the terminal equipment; or movement track information of the terminal equipment.

The technical solution the embodiments of the present disclosure can improve the accuracy of determining the satellite for locating the location of the terminal equipment, and thus improve the accuracy of locating the location of the terminal equipment.

FIG. 20 is a block diagram illustrating an apparatus for determining a locating satellite according to an embodiment of the present disclosure. The apparatus for determining the locating satellite is applied to a first network element.

As shown in FIG. 20, the apparatus may include: a third transmitting module 1601, configured to request satellite coverage information from a second network element, where the second network element is configured to manage or be capable of obtaining to the satellite coverage information; and a third receiving module 1602, configured to receive the satellite coverage information returned by the second network element, where the satellite coverage information is for determining satellite information of a locating satellite, and the locating satellite is configured to locate a terminal equipment.

In some embodiments, the third transmitting module 1601 is further configured to, after receiving the satellite coverage information returned by the second network element: determine, based on the satellite coverage information and access information of the terminal equipment, the satellite information of the locating satellite.

In some embodiments, the first network element is an access and mobility management function (AMF) network element or a mobility management entity (MME) network element; and the third transmitting module 1601 is further configured to, after determining, based on the satellite coverage information and the access information of the terminal equipment, the satellite information of the locating satellite: transmit a first location request carrying the satellite information of the locating satellite to a location management function (LMF) network element, where the first location request is for the LMF network element to instruct the locating satellite to locate the terminal equipment.

In some embodiments, the first network element is an AMF network element or an MME network element; and the third transmitting module 1601 is further configured to, after receiving the satellite coverage information returned by the second network element: transmit a second location request to an LMF network element, where the second location request carries the satellite coverage information and access information of the terminal equipment, and the second location request is for the LMF network element to determine the locating satellite based on the satellite coverage information and the access information of the terminal equipment, and to instruct the locating satellite to locate the terminal equipment.

In some embodiments, the first network element is an LMF network element, and the third receiving module 1602 is further configured to, before requesting the satellite coverage information from the second network element: receive a third location request transmitted by an AMF network element or an MME network element, where the third location request carries access information of the terminal equipment.

In some embodiments, the third transmitting module 1601 is further configured to transmit a fourth location request to a radio access network (RAN) network element, where the fourth location request carries the satellite information of the locating satellite, and the fourth location request is for requesting the RAN network element to instruct the locating satellite to locate the terminal equipment.

In some embodiments, the access information of the terminal equipment includes at least one of: location information of the terminal equipment; or movement track information of the terminal equipment.

In some embodiments, the second network element can be an AF network element, a satellite information management server, or a satellite network operation administration and maintenance (OAM) network element.

The technical solution the embodiments of the present disclosure can improve the accuracy of determining the satellite for locating the location of the terminal equipment, and thus improve the accuracy of locating the location of the terminal equipment.

FIG. 21 is a block diagram illustrating an apparatus for determining a locating satellite according to an embodiment of the present disclosure. The apparatus for determining the locating satellite is applied to a second network element.

As shown in FIG. 17, the apparatus includes: a fourth receiving module 1701, configured to receive an obtaining request transmitted by a first network element, where the obtaining request is for requesting to obtain satellite coverage information; and a fourth transmitting module 1702, configured to return the satellite coverage information to the first network element, where the satellite coverage information is for determining satellite information of a locating satellite, and the locating satellite is configured to locate a terminal equipment.

In some embodiments, the first network element can be an AMF network element, an MME network element, or an LMF network element.

In some embodiments, the second network element can be an AF network element, a satellite information management server, or a satellite network operation administration and maintenance (OAM) network element.

The technical solution the embodiments of the present disclosure can improve the accuracy of determining the satellite for locating the location of the terminal equipment, and thus improve the accuracy of locating the location of the terminal equipment.

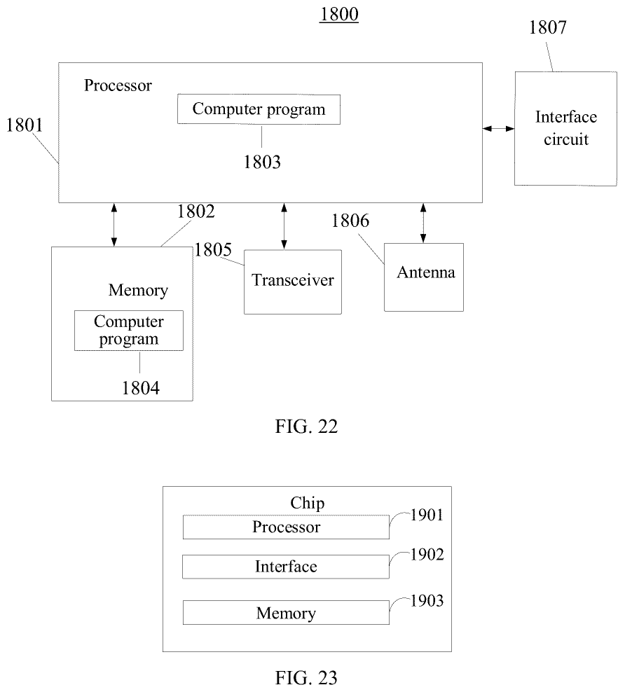

FIG. 22 is a structural schematic diagram illustrating a communication device 1800 according to an embodiment of the present disclosure. The communication device 1800 may be a network device, a user equipment, a chip, a chip system, or a processor, etc. that supports the network device to realize the method, or a chip, a chip system, or a processor, etc. that supports the user equipment to realize the method. This device can be used to implement the methods described in the method embodiments, which can be referred to in the description of the method embodiments.

The communication device 1800 may include one or more processors 1801. The processor 1801 may be a general purpose processor or a specialized processor, etc. For example, the processor may be a baseband processor or a central processing unit. The baseband processor can be used to process communication protocols and communication data, and the central processing unit can be used to control communication devices (such as base stations, baseband chips, terminal devices, terminal equipment chips, DU or CU, etc.), execute computer programs, and process data of computer programs.

In an embodiment, the communication device 1800 may further include one or more memories 1802, on which computer programs 1804 may be stored, and the processor 1801 executes the computer programs 1804, so that the communication device 1800 can perform the methods described in the method embodiments. In an embodiment, data can also be stored in the memory 1802. The communication device 1800 and the memory 1802 may be set separately or integrated together.

In an embodiment, the communication device 1800 may also include a transceiver 1805 and an antenna 1806. The transceiver 1805 can be called a transceiver unit, a transceiver device, a transceiver circuit, etc., and is used to realize the transmitting and receiving function. The transceiver 1805 may include a receiver and a transmitter. The receiver may be called a receiver device or a receiving circuit, etc., for realizing the receiving function. The transmitter can be called a transmitter device or a transmitting circuit, etc., and is used to realize the transmitting function.

In an embodiment, the communication device 1800 may also include one or more interface circuits 1807. The interface circuit 1807 is used to receive code instructions and transmit the code instructions to the processor 1801. The processor 1801 executes code instructions to cause the communication device 1800 to perform the methods in the method embodiments.

In an embodiment, the processor 1801 may include a transceiver for implementing the receiving and transmitting functions. For example, the transceiver can be a transceiver circuit, or an interface, or an interface circuit. Transceiver circuits, interfaces or interface circuits for receiving and transmitting functions can be separated or integrated. The transceiver circuit, interface or interface circuit can be used for reading and writing codes/data, or the transceiver circuit, interface or interface circuit can be used for signal transmission or transfer.

In an implementation, the processor 1801 can store computer programs 1803, and the computer programs 1803 runs on the processor 1801, which can cause the communication device 1800 to perform the methods in the method embodiments. The computer programs 1803 may be solidified in the processor 1801, in this case, the processor 1801 may be implemented by the hardware.

In an implementation, the communication device 1800 may include a circuit, which may realize the transmitting or receiving or communicating function in the method embodiments. The processor and the transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, and the like. The processor and the transceiver can also be manufactured by various IC process technologies, such as a complementary metal oxide semiconductor (CMOS), a nMetal-oxide-semiconductor (NMOS), a positive channel metal oxide semiconductor (PMOS), a bipolar junction transistor (BJT), a bipolar CMOS(BiCMOS), a silicon germanium (SiGe), a gallium arsenide (GaAs), etc.

The communication device in the embodiments may be a network device or a user equipment, but the scope of the communication device described in the present disclosure is not limited thereto, and the structure of the communication device may not be limited by FIG. 22. The communication device may be a stand-alone device or may be part of a larger device. For example, the communication device may be:
(1) independent integrated circuit (IC), or chip, or chip system or subsystem;
(2) one or more IC sets, optionally, the IC set may also include storage components for storing data and computer programs;
(3) ASIC, such as a modem;
(4) modules that can be embedded in other devices;
(5) a receiver, a terminal device, an intelligent terminal device, a cellular phone, a wireless device, a handset, a mobile unit, an on-board device, a network device, a cloud device, an artificial intelligence device, etc.;
(6) others and so on.

Referring to the structural schematic diagram of the chip shown in FIG. 23, the communication device can be a chip or a chip system. The chip shown in FIG. 23 includes a processor 1901 and an interface 1902. The number of processors 1901 may be one or more, and the number of interfaces 1902 may be plural.

The chip also includes a memory 1903, which is used to store necessary computer programs and data.

Those skilled in the art can also understand that various illustrative logical blocks and steps listed in the embodiments of the present disclosure can be implemented by an electronic hardware, a computer software, or a combination of both. Whether this function is realized by hardware or software depends on the specific application and the design requirements of the whole system. Those skilled in the art can use different methods to realize the described functions for each specific application, but this realization should not be considered beyond the scope of the technical solutions of the embodiments of the present disclosure.

The present disclosure also provides a readable storage medium having stored thereon instructions which, when executed by a computer, realize the functions of any of the method embodiments.

The present disclosure also provides a computer program product which, when executed by a computer, realizes the functions of any of the method embodiments.

In the above examples, it can be implemented in whole or in part by software, hardware, firmware, or any combination thereof. When implemented in software, it can be implemented in whole or in part in the form of a computer program product. The computer program product includes one or more computer programs. When computer programs are loaded and executed on a computer, the processes or function according to the examples of the present disclosure are generated in whole or in part. The computer can be a general-purpose computer, a dedicated computer, a computer network, or other programmable devices. Computer programs can be stored in a computer-readable storage medium or transmitted from one computer-readable storage medium to another computer-readable storage medium, for example, the computer programs can be transmitted from a website site, a computer, a trajectory prediction device or a data center via wire (For example, coaxial cable, optical fiber, digital subscriber line (DSL)) or wireless (for example, infrared, wireless, microwave, etc.) to another website, a computer, a trajectory prediction device, or a data center. The computer-readable storage medium can be any available medium that can be accessed by a computer or a data storage device including one or more available devices, data centers, and the like. The available media may be a magnetic media (e.g., a floppy disk, a hard disk, a tape), an optical media (e.g., a high-density digital video disc (DVD)), or a semiconductor media (e.g., a solid state disk (SSD)), and the like.

The embodiments of the present disclosure provide the method and apparatus for determining the locating satellite, which can improve the accuracy of determining the satellite for locating the location of the terminal equipment, and thus improve the accuracy of locating the location of the terminal equipment.

The person with ordinary skill in the art may understand that the first, second and other various numerical numbers involved in the present disclosure are only described for the convenience of differentiation, and are not used to limit the scope of the embodiments of the present disclosure, and also indicate the order of precedence.

The “at least one” of the present disclosure can also be described as one or more, and the “plurality” can be two, three, four or more, and the present disclosure is not limited. In this disclosed embodiment, for a technical feature, the technical features in the technical feature are distinguished by “first”, “second”, “third”, “A”, “B”, “C”, and “D”, etc. The technical features described by “first”, “second”, “third”, “A”, “B”, “C”, and “D” have no order of priority or size.

As used in this article, the terms “machine-readable medium” and “computer-readable medium” refer to any computer program product, device, and/or apparatus (e.g., disk, optical disk, memory, programmable logic device (PLD)) used to provide machine instructions and/or data to a programmable processor, including machine-readable media that receive machine instructions as machine-readable signals. The term “machine readable signal” refers to any signal used to provide machine instructions and/or data to a programmable processor.

The systems and technologies described herein can be implemented in computing systems that include backend components (such as data servers), middleware components (such as application servers), frontend components (such as user computers with graphical user interfaces or web browsers, through which users can interact with the implementation of the systems and technologies described herein), or any combination of such backend components, middleware components, or frontend components. The components of the system can be interconnected through any form or medium of digital data communication, such as a communication network. Examples of communication networks include a LAN, a WAN, and the internet.

The computing system can include clients and servers. A client and server are generally remote from each other and typically interact through a communication network. A client-server relationship is created by computer programs that run on corresponding computers and have a client-server relationship with each other.

It will be understood that steps can be reordered, added or deleted using the various forms of flow shown above. For example, the steps described in the present disclosure can be executed in parallel, sequentially or in a different order, so long as the desired results of the technical scheme disclosed in this disclosure can be achieved, there is no restriction here.

In addition, it will be understood that various embodiments described in this application can be implemented separately or in combination with other embodiments if the scheme allows.

Those skilled in the art can realize that the units and algorithm steps described in the embodiments disclosed in this article can be implemented through electronic hardware, or a combination of computer software and electronic hardware. Whether a function is performed as hardware or computer software driving hardware depends on the particular application and design constraints of the technical solution. Those skilled in the art can use different methods to realize the described functions for each specific application, but this realization should not be considered beyond the scope of the technical solutions of the embodiments of the present disclosure.

A person skilled in the art can clearly understand that, for the convenience and simplicity of description, the specific working processes of the system, apparatus and unit described above may refer to corresponding processes in the foregoing method embodiments, and details are not described herein again.

The above descriptions are merely specific examples of the present disclosure to which the scope of protection of the present disclosure is not limited. Any changes or substitutions that easily occur to those skilled in the art in the technical scope of the present disclosure should fall in the scope of protection of the present disclosure. Therefore, the scope of protection of the present disclosure is indicated as in appended claims.

1. A method for determining a locating satellite, performed by a first network element, comprising:
transmitting a first request to a second network element, wherein the first request carries access information of a terminal, the first request is for requesting information of a satellite for locating the terminal, and the second network element is configured to manage or be capable of obtaining satellite network operation information; and
receiving satellite information of a locating satellite returned by the second network element, wherein the locating satellite is determined by the second network element based on the access information of the terminal.

2. The method of claim 1, wherein the first network element is an access and mobility management function (AMF) network element or a mobility management entity (MME) network element; and
wherein the method further comprises:
after receiving the satellite information of the locating satellite returned by the second network element, transmitting a first location request carrying the satellite information of the locating satellite to a location management function (LMF) network element, wherein the first location request is for the LMF network element to instruct the locating satellite to locate the terminal.

3. The method of claim 1, wherein the first network element is an LMF network element; and
wherein the method further comprises:
before transmitting the first request to the second network element, receiving a second request transmitted by an AMF network element or an MME network element, wherein the second request comprises the access information of the terminal, and the second request is for requesting to locate the terminal.

4. The method of claim 3, further comprising:
after receiving the satellite information of the locating satellite returned by the second network element, transmitting a third request to a radio access network (RAN) network element, wherein the third request carries the satellite information of the locating satellite, and the third request is for requesting the RAN network element to instruct the locating satellite to locate the terminal.

5. The method of claim 1, wherein the first request further carries indication information, and the indication information is for the second network element to determine the satellite for locating the terminal.

6. (canceled)

7. The method of claim 1, wherein the access information of the terminal comprises at least one of: location information of the terminal; or movement track information of the terminal.

8. A method for determining a locating satellite, performed by a second network element configured to manage or be capable of obtaining satellite network operation information, comprising:
receiving a first request transmitted by a first network element, wherein the first request is for requesting information of the satellite for locating a terminal, and the first request carries access information of the terminal;
determining, based on the access information of the terminal, satellite information of a locating satellite; and
returning the satellite information of the locating satellite to the first network element.

9. The method of claim 8, wherein determining, based on the access information of the terminal, the satellite information of the locating satellite comprises:
determining one or more satellites whose satellite signals cover at least one of a current location or a movement track of the terminal as a locating satellite.

10. The method of claim 8, further comprising:
in response to the first request carrying indication information, determining one or more satellites whose satellite signals cover at least one of a current location or a movement track of the terminal as a locating satellite, wherein the locating satellite comprises a satellite accessed by the terminal.

11. The method of claim 8, further comprising:
receiving an obtaining request transmitted by the first network element, wherein the obtaining request is for requesting to obtain satellite coverage information; and
returning the satellite coverage information to the first network element, wherein the satellite coverage information is for determining the satellite information of the locating satellite.

12. (canceled)

13. (canceled)

14. A method for determining a locating satellite, performed by a first network element, comprising:
requesting satellite coverage information from a second network element, wherein the second network element is configured to manage or be capable of obtaining to the satellite coverage information; and
receiving the satellite coverage information returned by the second network element, wherein the satellite coverage information is for determining satellite information of a locating satellite, and the locating satellite is configured to locate a terminal.

15. The method of claim 14, further comprising:
after receiving the satellite coverage information returned by the second network element, determining, based on the satellite coverage information and access information of the terminal, the satellite information of the locating satellite.

16. The method of claim 15, wherein the first network element is an access and mobility management function (AMF) network element or a mobility management entity (MME) network element; and
wherein the method further comprises:
after determining, based on the satellite coverage information and the access information of the terminal, the satellite information of the locating satellite, transmitting a first location request carrying the satellite information of the locating satellite to a location management function (LMF) network element, wherein the first location request is for the LMF network element to instruct the locating satellite to locate the terminal.

17. The method of claim 14, wherein the first network element is an AMF network element or an MME network element; and
wherein the method further comprises:
after receiving the satellite coverage information returned by the second network element, transmitting a second location request to an LMF network element, wherein the second location request carries the satellite coverage information and access information of the terminal, and the second location request is for the LMF network element to determine the locating satellite based on the satellite coverage information and the access information of the terminal, and to instruct the locating satellite to locate the terminal.

18. The method of claim 15, wherein the first network element is an LMF network element; and
wherein the method further comprises:
before requesting the satellite coverage information from the second network element, receiving a third location request transmitted by an AMF network element or an MME network element, wherein the third location request carries access information of the terminal.

19. The method of claim 18, further comprising:
after determining, based on the satellite coverage information and the access information of the terminal, the satellite information of the locating satellite, transmitting a fourth location request to a radio access network (RAN) network element, wherein the fourth location request carries the satellite information of the locating satellite, and the fourth location request is for requesting the RAN network element to instruct the locating satellite to locate the terminal.

20-29. (canceled)

30. A communication device, comprising:
a transceiver;
a memory; and
a processor connected to the transceiver and the memory, respectively, wherein the processor is configured to perform the method of claim 1.

31. (canceled)

32. A communication device, comprising:
a transceiver;
a memory; and
a processor connected to the transceiver and the memory, respectively, wherein the processor is configured to perform the method of claim 8.

33. A communication device, comprising:
a transceiver;
a memory; and
a processor connected to the transceiver and the memory, respectively, wherein the processor is configured to perform the method of claim 14.
